(19) United States
(12) Patent Application Publication
(10) Pub. No.: US 2022/0100912 A1
(43) Pub. Date: Mar. 31, 2022

(54) PRIVACY DISPLAYS WITH PIEZO ELECTRIC LAYERS

(71) Applicant: Hewlett-Packard Development Company, L.P., Spring, TX (US)

(72) Inventors: Hsing-Hung Hsieh, Taipei City (TW); Kuan-Ting Wu, Taipei City (TW); Ann Alejandro Villegas, Spring, TX (US)

(73) Assignee: Hewlett-Packard Development Company, L.P., Spring, TX (US)

(21) Appl. No.: 17/297,274

(22) PCT Filed: Jun. 19, 2019
(86) PCT No.: PCT/US2019/037887

§ 371 Date: May 26, 2021

(51) Int. Cl. G06F 21/84; G09G 3/32

(52) U.S. Cl. CPC G06F 21/84; G09G 2358/00; G09G 2320/028; G09G 3/32

(57) ABSTRACT

In example implementations, a display is provided. The display includes a piezo electric layer coupled to a power source, a plurality of light emitting diodes arranged on the piezo electric layer, an aperture layer, a thin film transistor layer, a liquid crystal layer formed over the thin film transistor layer, and a color filter layer. The aperture layer is located above the plurality of light emitting diodes such that light emitted from the plurality of light emitting diodes travels through respective apertures in the aperture layer. The color filter layer is formed over the liquid crystal layer to control a color of the light emitted from the plurality of light emitting diodes.

### BACKGROUND

Displays can be used to produce visible images. Displays have evolved over time from cathode ray tube (CRT) based displays to light emitting diode (LED) based displays. The LED based displays can provide a smaller and lighter display that is more energy efficient than CRT based displays.

LED based displays can have a wide viewing angle as light is distributed at wide angles from the LEDs. Emitting light at wide viewing angles may allow a user to see the display at a variety of viewing positions rather than having to sit directly in front of the display. However, wide viewing angles may also allow neighbors sitting next to a user to view the display.

### BRIEF DESCRIPTION OF THE DRAWINGS

FIG. 1 is a block diagram of an example cross-sectional view of a display of the present disclosure;

FIG. 2 is a block diagram of an example of the LEDs on a piezo electric layer in a sharing mode of the present disclosure;

FIG. 3 is a block diagram of an example of the LEDs on the piezo electric layer in a privacy mode of the present disclosure;

FIG. 4 is a block diagram of an example viewing ranges of the sharing mode and the privacy mode of the present disclosure;

FIG. 5 is a flow chart of an example method for activating a privacy mode on a display the present disclosure; and

FIG. 6 is a block diagram of an example non-transitory computer readable storage medium storing instructions executed by a processor to activate a privacy mode on a display.

### DETAILED DESCRIPTION

Examples described herein provide displays that use piezo electric materials. As discussed above, some LED based displays may have wide viewing angles. As a result, if a user is looking at sensitive information on the display, neighbors sitting next to the user may also view the display and see the sensitive information. Some users would like a privacy mode to prevent others from viewing information that is on the display.

Examples herein provide a display that uses piezo electric materials to enable a privacy mode on the display. The LEDs of the display may be located on the piezo electric material. An aperture layer may be located over the LEDs. The LEDs may be moved relative to the aperture layer to either provide a wide angle light distribution or a narrow angle light distribution that may be associated with a sharing mode or a privacy mode, respectively. The piezo electric material may change in thickness when exposed to current or voltage to provide the movement of the LEDs relative to the aperture layer.

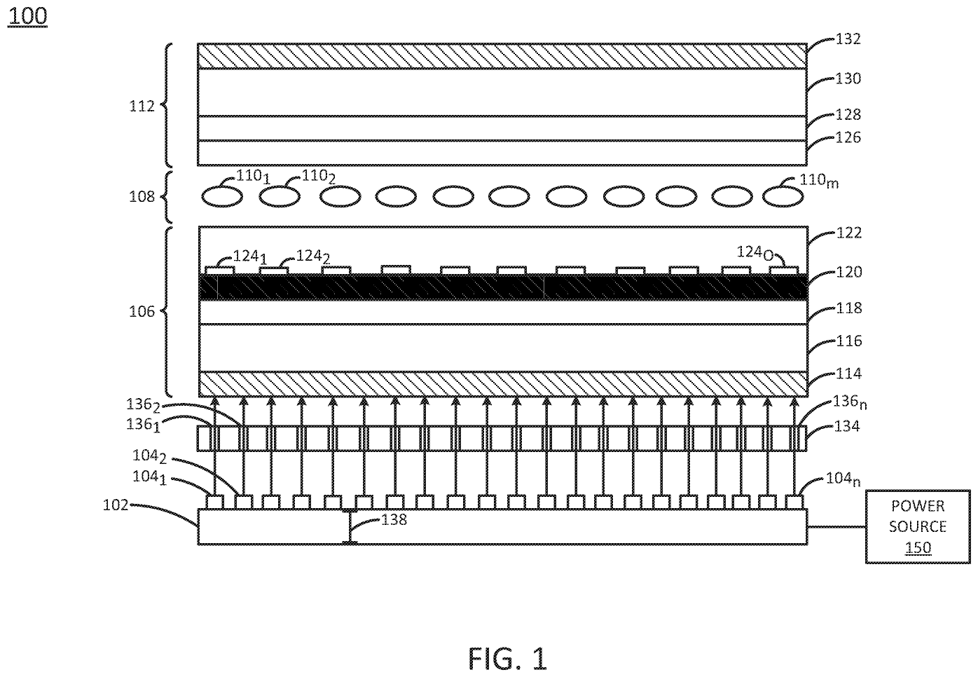

FIG. 1 illustrates an example cross-sectional view of a display 100 with piezo electric materials for an electronic device of the present disclosure. The display 100 may be part of an electronic device such as a television, a computer monitor, a display of a laptop computer, or a tablet computer. The display 100 may be used to generate an image or motion video. The display 100 may provide color images using any color display technology (e.g., a red, green, blue (RGB) display).

In an example, the display 100 may include a piezo electric layer 102 with a plurality of light emitting diodes (LEDs) 104₁ to 104ₙ (hereinafter also referred to individually as an LED 104 or collectively as LEDs 104). The plurality of LEDs 104 may be arranged on the piezo electric layer 102. The LEDs 104 may provide light to display an image on the display 100. The LEDs 104 may emit enough light or luminance to illuminate the display 100. The size or brightness of the LEDs 104 may be a function of a size of the display 100. For example, a large display may use brighter LEDs 104. A smaller display may use either fewer LEDs 104 or dimmer LEDs.

An aperture layer 134 may be located over the LEDs 104. The aperture layer 134 may be fabricated from a plastic or a metal. The aperture layer 134 may include a plurality of apertures 136₁-136ₙ (hereinafter also referred to individually as an aperture 136 or collectively as apertures 136). The aperture layer 134 may be molded to form the apertures 136 or the apertures 136 may be punched out of a solid layer of material used to form the aperture layer 134.

In one example, the number of apertures 136 may be the same as the number of LEDs 104. In one example, each LED 104 may correspond to a respective aperture 136 of the aperture layer 134. For example, an aperture 136 may be located over each one of the LEDs 104. Said another way, a central light emitting axis of an LED 104 may be aligned with a center of an aperture 136. In one example, the apertures 136 may each have a diameter of approximately 10-300 microns.

In one example, the aperture layer 134 may be located over the LEDs 104 such that light emitted from the LEDs 104 may travel through the respective apertures 136 in the aperture layer 134. As discussed in further details below, the LEDs 104 may be moved relative to the aperture layer 134 to change an angle of the light emitted through the apertures 136. A privacy mode or a sharing mode may be enabled based on the angle of the light emitted through the apertures 136.

In one example, the piezo electric layer 102 may be formed from a piezo electric material. Examples of the piezo electric material may include lithium niobate, lithium tantalite, barium titanate, bismuth ferrite, bismuth titanate, gallium arsenide, zinc oxide, aluminum nitride, lead zirconate-titanate (PZT), lead lanthanum zirconate titanate (PLZT), sodium bismuth titanate, and polyvinylidene fluoride (PVDF). In one example, the composition of PLZT may be approximately 40-70 wt %, or 55-65 wt % of PbO, approximately 5-20 wt %, or 7-12 wt % of La₃O₃, approximately 15-35 wt %, or 18-28 wt % of ZrO₂, and approximately 3-15 wt %, or 6-10 wt % of TiO₂.

The piezo electric layer 102 may have a thickness of less than 1 millimeter (mm). In one example, the thickness may be approximately 0.1-0.5 mm.

A thickness, as shown by line 138, of the piezo electric layer 102 may change as a current is applied to the piezo electric layer 102. The amount of change in the thickness of the piezo electric layer 102 may be dependent on the type of piezo electric material that is used to form the piezo electric layer 102. Different piezo electric materials may respond differently to the same current or voltage that is applied.

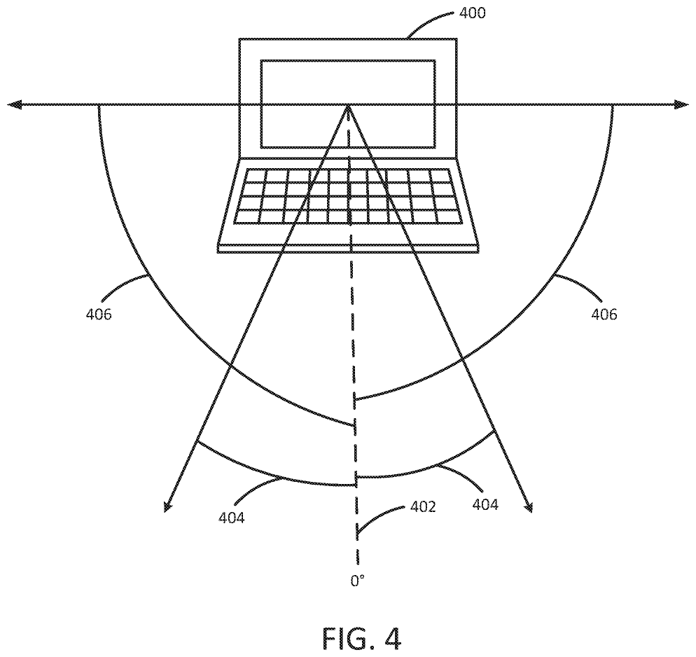

As the thickness of the piezo electric layer 102 changes, the distance between the LEDs 104 and the aperture layer 134 may also change. The piezo electric layer 102 may have an initial thickness associated with a sharing mode that positions the plurality of LEDs relative to the aperture layer 134 to distribute light emitted from LEDs 104 at a wide angle. When a current flows through the piezo electric layer 102, the piezo electric layer may have a compressed thickness that lowers the position of the plurality of LEDs along a z-direction relative to the aperture layer 134. The compressed thickness of the piezo electric layer 102 may be associated with a privacy mode that positions the plurality of LEDs 104 relative to the aperture layer 134 to distribute light emitted from the plurality of LEDs 104 at a narrow angle. The values for the “narrow angles” and the “wide angles” are described below in conjunction with FIG. 4.

In one example, the piezo electric layer 102 may be coupled to a power source 150. The power source 150 may apply a current or a voltage to the piezo electric layer 102. The current or the voltage may cause a thickness of the piezo electric layer 102 to change, as noted above. In one example, the piezo electric layer 102 may have a default or initial thickness when no current is applied. The default thickness may be associated with a sharing mode where the LEDs 104 are relatively close to the aperture layer 134.

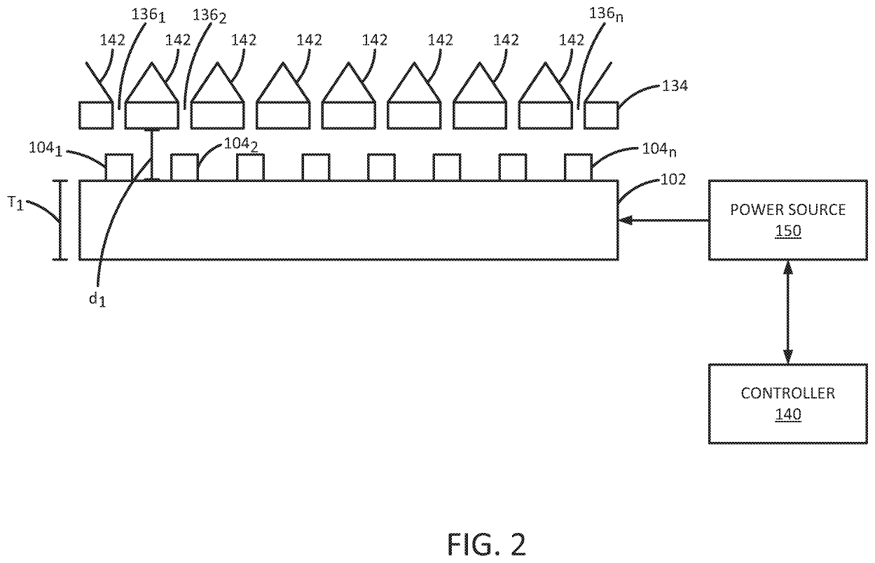

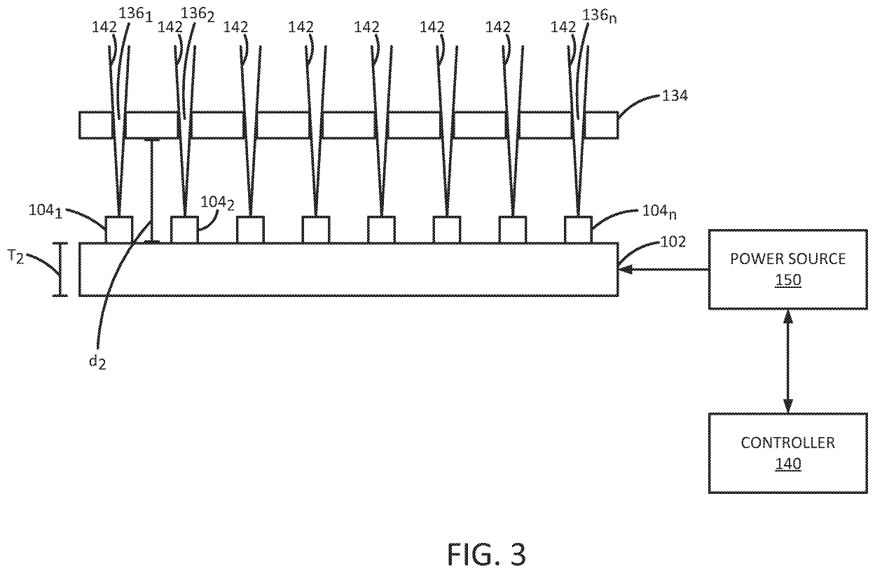

When the power source 150 is activated, current may be applied to the piezo electric layer 102. The current may cause the piezo electric layer 102 to change in thickness, or to be reduced to a compressed thickness, which may cause the LEDs 104 to move away from the aperture layer 134. The change in thickness may be associated with a privacy mode. In other words, when the privacy mode is activated, the power source 150 may be activated to apply a current through the piezo electric layer 102. Examples of different thicknesses and positions of the piezo electric layer 102 relative to the aperture layer 134 are illustrated in FIGS. 2 and 3 and discussed in further details below.

The display 100 may also include a thin film transistor (TFT) layer 106 formed over the aperture layer 134 and the LEDs 104. The TFT layer 106 may control emission of light from the LEDs 104. The TFT layer 106 may include a glass substrate 116. The glass substrate 116 may have a thickness of approximately 0.1-1.0 mm. In one example, the thickness may be approximately 0.2-0.4 mm.

A polarizer 114 may be located on a bottom side of the glass substrate 116 and a common electrode 118 may be located on a top side of the glass substrate 116. The polarizer 114 may have a thickness of less than 1.0 mm. In one example, the polarizer 114 may have a thickness of less than 0.5 mm. In one example, the polarizer 114 may be approximately 0.1 mm thick. The common electrode 118 may have a thickness of less than 200 nanometers (nm). In one example, the thickness of the common electrode 118 may be approximately 40-100 nm.

The TFT layer 106 may include an insulator 120 on the common electrode 118 and an alignment layer 122 having a plurality of pixel electrodes 124₁ to 124₀ (hereinafter also referred to individually as a pixel electrode 124 or collectively as pixel electrodes 124). In one example, the insulator 120 may have a thickness of less than 1000 nm. In one example, the thickness of the insulator 120 may be approximately 200-700 nm. In one example, the thickness of the insulator 120 may be approximately 300-500 nm. In one example, the alignment layer 122 may have a thickness of less than 50 nm. In one example, the thickness of the alignment layer 122 may be between approximately 5-20 nm. In one example, the thickness of the alignment layer 122 may be approximately 10 nm.

The display 100 may include a liquid crystal layer 108 over the TFT layer 106. The liquid crystal layer 108 may be located between the TFT layer 106 and a color filter (CF) layer 112.

The liquid crystal layer 108 may include a plurality of liquid crystals 110₁ to 110ₘ (hereinafter also referred to individually as a liquid crystal 110 or collectively as liquid crystals 110). The orientation of the liquid crystals 110 may determine whether light emitted from the LEDs 104 passes through to a particular pixel of the display 100. In one example, the orientation of the liquid crystals 110 can be controlled by applying a voltage to a respective pixel electrode 124. In one example, a pixel electrode 124 may be approximately 20-200 nm thick. In one example, the thickness of a pixel electrode 124 may be approximately 40-100 nm. The power source used to apply the voltage to the pixel electrodes 124 may be the power source 150 or may be a separate power source.

In one example, the alignment layer 122 may be a rubbed polyimide layer on the pixel electrodes 124. The pixel electrodes 124 may control respective liquid crystals 110 and remain aligned with the respective liquid crystals 110.

The CF layer 112 may be formed over the liquid crystal layer 108 to control a color of light emitted from the plurality of LEDs 104. The CF layer 112 may include a glass substrate 130 with color filters, and a polarizer 132 may be located on a top side of the glass substrate 130. The glass substrate 130 may have a thickness of approximately 0.1-1.0 millimeters (mm). In one example, the thickness of the glass substrate 130 may be approximately 0.2-0.4 mm. The polarizer 132 may have a thickness of less than 1.0 mm. In one example, the polarizer 132 may have a thickness of less than 0.5 mm. In one example, the polarizer 132 may be approximately 0.1 mm.

The color filters in the glass substrate 130 may be red, green, and blue color filters that help to convert light emitted by the LEDs 104 into a desired color that is shown on the display 100. A common electrode 128 may be located on a bottom side of the glass substrate 130. An alignment layer 126 may be a rubbed polyimide layer formed on a bottom side of the common electrode 128. In one example, the alignment layer 126 may have a thickness of less than 50 nm. In one example, the thickness of the alignment layer 126 may be between approximately 5-20 nm. In one example, the thickness of the alignment layer 126 may be approximately 10 nm. The common electrode 128 may have a thickness of less than 200 nanometers (nm). In one example, the thickness of the common electrode 128 may be approximately 40-100 nm.

FIGS. 2 and 3 illustrate different positions of the piezo electric layer 102. For example, FIG. 2 illustrates an example of the LEDs 104 on the piezo electric layer 102 in a sharing mode. FIG. 2 has been simplified for ease of explanation to show the piezo electric layer 102 and the aperture layer 134 without the additional layers of the display 100 illustrated in FIG. 1.

In one example, the piezo electric layer 102 may be coupled to the power source 150, as described above. A controller 140 may be communicatively coupled to the power source 150 to control operation of the power source 150 based on a signal to enable a sharing mode or a privacy mode. For example, a graphical user interface or a physical button on the display 100 may allow a user to select the sharing mode or the privacy mode. When the user selects a sharing mode or a privacy mode, a signal may be sent to the controller 140 to control the power source 150 accordingly. In one example, the controller 140 may be a processor or an application specific integrated circuit (ASIC) to perform a particular function.

In the sharing mode, the power source 150 may not provide any current to the piezo electric layer 102. The piezo electric layer 102 may have a default thickness T₁. At the thickness T₁, a top surface of the piezo electric layer 102 may be a distance d₁ from a bottom surface of the aperture layer 134. The distance d₁ may allow the LEDs 104 to be relatively close to the respective apertures 136 of the aperture layer 134. As a result, light 142 emitted from the LEDs 104 may pass through the apertures 136 at a relatively wide angle to allow users located at wide angles to view the display 100.

FIG. 3 illustrates an example of the LEDs 104 on the piezo electric layer 102 in a privacy mode. For example, a user may be in an airplane and may not want neighbors sitting nearby to be able to view the display 100. In another example, the user may be at the library studying and not want others to see the display 100. In another example, the displays 100 may be issued to students to take an exam. The displays 100 may be set to privacy mode such that students sitting next to each other cannot see other students' displays to cheat during the exam. The user may select the privacy mode via the graphical user interface or the physical button, as described above.

In response, a signal may be sent to the controller 140 indicating that the privacy mode is selected. The controller 140 may cause the power source 150 to generate a current or a voltage that is applied to the piezo electric layer 102. The current or the voltage applied to the piezo electric layer 102 may cause the piezo electric layer 102 to change in thickness. For example, the piezo electric layer 102 may shrink or compress to a thickness T₂.

In one example, the thickness T₂ may be less than T₁. In one example, the amount of movement (e.g., the difference between Ti and Tz) may be approximately 0.1 to 1.5 millimeters (mm) in the z-direction. In one example, the amount of movement may be approximately 0.3-1.2 mm. In one example, the amount of movement may be approximately 0.5-1.0 mm. The z-direction may be in a direction that runs up and down along the line referenced by distance d₂. In other words, the piezo electric layer 102 may move the LEDs 104 relative to the aperture layer 134 along the z-direction by approximately 0.1 to 1.5 mm.

When the current or the voltage is applied to the piezo electric layer 102, the piezo electric layer 102 may shrink to a thickness T₂ and move to a distance d₂ from the aperture layer 134. The distance d₂ may be measured from the top surface of the piezo electric layer 102 to the bottom surface of the aperture layer 134. The distance d₂ may allow the LEDs 104 to be relatively far away from the respective apertures 136 of the aperture layer 134. For example, the distance d₂ may be greater than the distance d₁. The actual values of T₁, T₂, d₁, and d₂ may vary and be a function of the diameter of the apertures 136 to achieve the viewing angles for the privacy mode and the sharing mode, as defined in FIG. 4 and discussed below. As a result, the light 142 emitted from the LEDs 104 may pass through the apertures 136 at a relative narrow angle to prevent users located at wide angles from viewing the display 100.

FIG. 4 illustrates an example of the viewing ranges of the sharing mode and the privacy mode of the present disclosure. FIG. 4 illustrates an apparatus 400. For example, the display of the apparatus 400 may be the display 100 illustrated in FIGS. 1-3 above. In one example, the apparatus 400 may be a laptop computer, a tablet computer, or a monitor.

In one example, the viewing angles may be defined relative to a person who is sitting in front of the apparatus 400 and centered to the apparatus 400 at an angle of 0 degrees as illustrated by line 402. In one example, the line 402 may be a central light emitting axis of the display. In one example, the viewing angles may be defined relative to either side of a central light emitting axis of each LED 104 through the respective apertures 136. The viewing angles through the apertures 136 may be combined to achieve the overall viewing angle for the privacy mode or the sharing mode.

In one example, the angles 404 on either side of the line 402 may define the viewing angles in the privacy mode. The angles 404 may be relatively narrow such that individuals who are viewing the display of the apparatus 400 outside of the angles 404 cannot view the display of the apparatus 400.

In one example, the angles 404 may be approximately 15 degrees to 45 degrees to either side of the line 402. For example, the angles 404 could be +/−15 degrees to +/−45 degrees. Said another way, the total viewing angle may be approximately a total of 30 degrees to 90 degrees. In one example, the angles 404 may be approximately +/−25 degrees to +/−35 degrees. In one example, the angles 404 may be approximately +/−30 degrees.

In one example, the angles 406 on either side of the line 402 may define the viewing angles in the sharing mode. The angles 406 may be relatively wide such that individuals who are viewing the display of the apparatus 400 within the angles 406 may be able to view the display of the apparatus 400.

In one example, the angles 406 may be approximately 45 degrees to 90 degrees to either side of the line 402. For example, the angles 406 could be +/−45 degrees to +/−90 degrees. Said another way, the total viewing angle may be approximately a total of 90 degrees to 180 degrees. In one example, the angles 406 may be +/−55 degrees to +/−80 degrees. In one example, the angles 406 may be +/−65 degrees to +/−70 degrees.

In one example, the user may dynamically change the viewing angles 404 and 406 that define the privacy mode and the sharing mode. For example, the user may want to share the display 400 with another user sitting side-by-side. However, the users may not want others around them to be able to view the display of the apparatus 400. The two users may sit at a viewing angle that is outside of an initial viewing angle 404 that is set as the privacy mode (e.g., at 50 degrees on either side of the line 402).

In one example, the users may select the viewing angle 404 for the privacy mode such that both users may view the display on the apparatus 400. The controller 140 may determine the desired thickness of the piezo electric layer 102 such that the light is emitted through the apertures 136 to achieve a privacy mode viewing angle selected by the users (e.g., 50 degrees). The controller 140 may determine the amount of current or voltage to be applied to the piezo electric layer 102 to achieve the desired thickness. The controller 140 may then control the power source 150 to apply the correct amount of current or voltage to change the thickness of the piezo electric layer 102 to the desired thickness to achieve the user selected viewing angle for the privacy mode.

Thus, the piezo electric layer 102 may be electronically controlled to move the LEDs 104 closer to the apertures 136 or further away from the apertures 136 based on whether the privacy mode or the sharing mode is selected. The piezo electric layer 102 may provide a way to provide a privacy mode for the display 100.

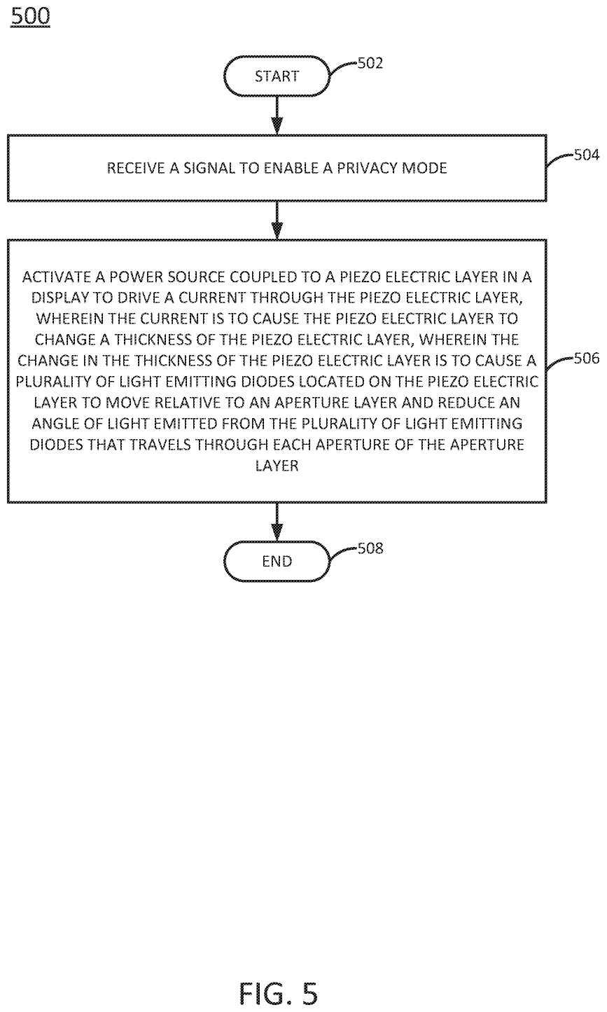

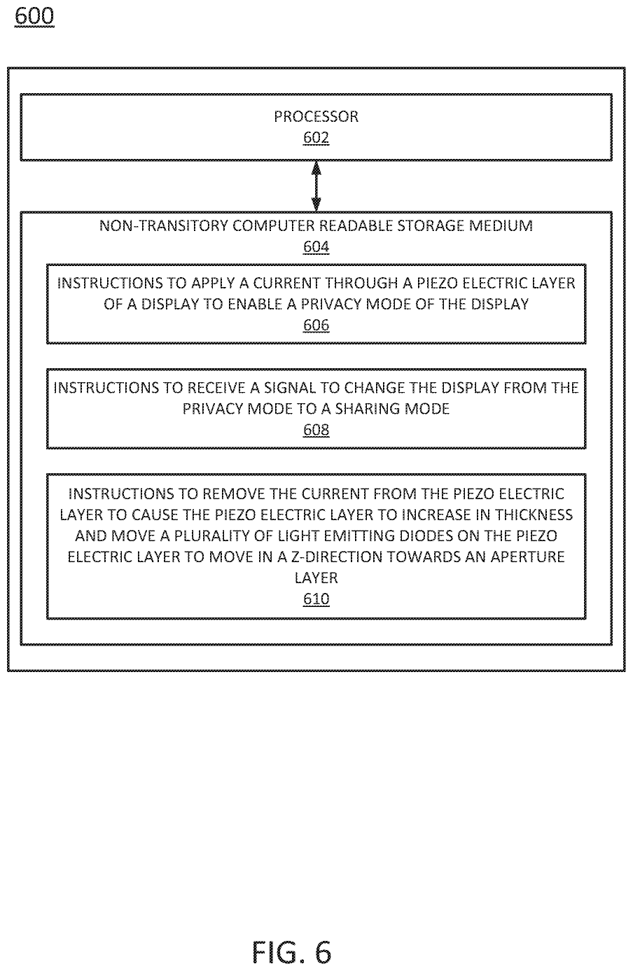

FIG. 5 illustrates a flow diagram of an example method 500 for activating a privacy mode on a display the present disclosure. In an example, the method 500 may be performed by the display 100, the apparatus 400, or the apparatus 600 illustrated in FIG. 6, and described below.

At block 502, the method 500 begins. At block 504, the method 500 receives a signal to enable a privacy mode. For example, a user may select the privacy mode via a graphical user interface shown on the display or a physical button. The privacy mode may cause the display to emit light at a relatively narrow angle such that users outside of the viewing angle may be unable to view the display.

At block 506, the method 500 activates a power source coupled to a piezo electric layer in a display to drive a current through the piezo electric layer, wherein the current is to cause the piezo electric layer to change a thickness of the piezo electric layer, wherein the change in the thickness of the piezo electric layer is to cause a plurality of light emitting diodes located on the piezo electric layer to move relative to an aperture layer and reduce an angle of light emitted from the plurality of light emitting diodes that travels through each aperture of the aperture layer. In one example, the current may cause the piezo electric layer to change in thickness by approximately 0.1 to 1.5 mm. In one example, the amount of change may be approximately 0.3-1.2 mm. In one example, the amount of change may be approximately 0.5-1.0 mm. When the privacy mode is activated, the thickness of the piezo electric layer may be reduced by approximately 0.1 to 1.5 mm. In one example, the reduction in thickness may be approximately 0.3-1.2 mm. In one example, the reduction in thickness may be approximately 0.5-1.0 mm. As a result, the LEDs on the piezo electric layer may be moved away from the apertures in the aperture layer.

When located further away from the apertures, the light emitted from the LEDs may pass through the apertures at a relatively narrow angle. As described above, the viewing angles for the privacy mode may be approximately 15 degrees to 45 degrees on either side of a line from the center of the display to a user sitting centered to and in front of the display.

In one example, a second signal may be received to disable the privacy mode. For example, the user may finish in the privacy mode and want to enable the sharing mode to watch a movie with other individuals who are nearby.

The power source may be deactivated to remove the current through the piezo electric layer to cause the piezo electric layer to change to an initial thickness. In other words, if the current causes the piezo electric layer to shrink in thickness along a z-direction by 0.1 to 1.5 mm relative to the aperture layer, then removing the current may cause the piezo electric layer to increase in thickness along the z-direction by 0.1 to 1.5 mm relative to the aperture layer.

In one example, the reduction in thickness or the increase in thickness may be approximately 0.3-1.2 mm. In one example, the reduction in thickness or the increase in thickness may be approximately 0.5-1.0 mm. The piezo electric layer may move the plurality of LEDs relative to the aperture layer to increase the angle of light emitted from the plurality of LEDs that travel through each aperture of the aperture layer.

When located closer to the apertures, the light emitted from the LEDs may pass through the apertures at a relatively wide angle. As described above, the viewing angles for the sharing mode may be approximately 45 degrees to 90 degrees on either side of a line from the center of the display to a user sitting centered to and in front of the display. At block 508, the method 500 ends.

FIG. 6 illustrates an example of an apparatus 600. In an example, the apparatus 600 may be the device 100 or 400. In an example, the apparatus 600 may include a processor 602 and a non-transitory computer readable storage medium 604. The non-transitory computer readable storage medium 604 may include instructions 606, 608, and 610 that, when executed by the processor 602, cause the processor 602 to perform various functions.

In an example, the instructions 606 may include instructions to apply a current through a piezo electric layer of a display to enable a privacy mode of the display. The instructions 608 may include instructions to receive a signal to change the display from the privacy mode to a sharing mode. The instructions 610 may include instructions to remove the current from the piezo electric layer to cause the piezo electric layer to increase in thickness and move a plurality of light emitting diodes on the piezo electric layer to move in a z-direction towards an aperture layer.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A display for an electronic device, comprising:
a piezo electric layer coupled to a power source;
a plurality of light emitting diodes arranged on the piezo electric layer;
an aperture layer located above the plurality of light emitting diodes such that light emitted from the plurality of light emitting diodes travels through respective apertures in the aperture layer;
a thin film transistor layer formed over the aperture layer;
a liquid crystal layer formed over the thin film transistor layer; and
a color filter layer formed over the liquid crystal layer to control a color of the light emitted from the plurality of light emitting diodes.

2. The display of claim 1, wherein the piezo electric layer comprises at least one of: lithium niobate, lithium tantalite, barium titanate, bismuth ferrite, bismuth titanate, gallium arsenide, zinc oxide, aluminum nitride, lead zirconate-titanate, lead lanthanum zirconate titanate (PLZT), sodium bismuth titanate, or polyvinylidene fluoride.

3. The display of claim 1, wherein the piezo electric layer has an initial thickness associated with a sharing mode that positions the plurality of the light emitting diodes relative to the aperture layer to distribute light emitted from the plurality of light emitting diodes at a wide angle.

4. The display of claim 1, wherein the piezo electric layer has a compressed thickness when a current through the piezo electric layer.

5. The display of claim 4, wherein the compressed thickness lowers a position of the plurality of light emitting diodes along a z-direction relative to the aperture layer.

6. The display of claim 5, wherein a movement along the z-direction comprise approximately 0.1 millimeters to 1.5 millimeters.

7. The display of claim 5, wherein the compressed thickness is associated with a privacy mode that positions the plurality of light emitting diodes relative to the aperture layer to distribute light emitted from the plurality of light emitting diodes at a narrow angle.

8. The display of claim 1, wherein a diameter of each aperture in the aperture layer is approximately 10 microns to 300 microns.

9. The display of claim 1, wherein the aperture layer comprises an aperture located over each one of the plurality of light emitting diodes.

10. A method comprising:
receiving, by a processor, a signal to enable a privacy mode; and
activating, by the processor, a power source coupled to a piezo electric layer in a display to drive a current through the piezo electric layer, wherein the current is to cause the piezo electric layer to change a thickness of the piezo electric layer, wherein the change in the thickness of the piezo electric layer is to cause a plurality of light emitting diodes located on the piezo electric layer to move relative to an aperture layer and reduce an angle of light emitted from the plurality of light emitting diodes that travels through each aperture of the aperture layer.

11. The method of claim 10, further comprising:
receiving, by the processor, a second signal to disable the privacy mode; and
deactivating, by the processor, the power source to remove the current through the piezo electric layer to cause the piezo electric layer to change to an initial thickness and to move the plurality of light emitting diodes relative to the aperture layer to increase the angle of light emitted from the plurality of light emitting diodes that travels through each aperture of the aperture layer.

12. The method of claim 10, wherein the movement of the plurality of light emitting diodes is along a z-direction relative to the aperture layer.

13. A non-transitory computer readable storage medium encoded with instructions executable by a processor, the non-transitory computer-readable storage medium comprising:
instructions to apply a current through a piezo electric layer of a display to enable a privacy mode of the display;
instructions to receive a signal to change the display from the privacy mode to a sharing mode; and
instructions to remove the current from the piezo electric layer to cause the piezo electric layer to increase in thickness and move a plurality of light emitting diodes on the piezo electric layer to move in a z-direction towards an aperture layer.

14. The non-transitory computer readable storage medium of claim 13, wherein an angle of light emitted from the plurality of light emitting diodes through each aperture in the aperture layer in the privacy mode comprises approximately +/−15 degrees to approximately +/−45 relative to a central light emitting axis of each aperture.

15. The non-transitory computer readable storage medium of claim 13, wherein the angle of light emitted from the plurality of light emitting diodes through each aperture in the aperture layer in the sharing mode comprises approximately +/−45 degrees to approximately +/−90 degrees relative to a central light emitting axis of each aperture.
